(19) United States
(12) Patent Application Publication
(10) Pub. No.: US 2008/0155291 A1
(43) Pub. Date: Jun. 26, 2008

(54) METHOD FOR RESETTING MICRO CONTROLLER

(75) Inventors: Wen-Chi Hsu, Changhua County (TW); Shu-Hua Kuo, Hsinchu City (TW); Chao-Chung Chang, Nantou County (TW); Rong-Yau Tsai, Taipei County (TW); Jia-Jou Tsai, Taipei City (TW)

Correspondence Address: WPAT, PC, 7225 BEVERLY ST., ANNANDALE, VA, 22003, US

(73) Assignee: HOLTEK SEMICONDUCTOR INC., Hsinchu (TW)

(21) Appl. No.: 11/963,735

(22) Filed: Dec. 21, 2007

(30) Foreign Application Priority Data
Dec. 26, 2006 (TW) 095148901

(51) Int. Cl. G06F 1/32

(52) U.S. Cl. 713/324

(57) ABSTRACT

A method for resetting a micro controller is disclosed. The method uses an improved micro controller reset circuit designed for loading micro controller options regardless of whether a reset key is pressed after the power is turned on. In this method, the initial values of the micro controller are recovered so as to reduce power consumption and avoid conflict between signals.

### BACKGROUND OF THE INVENTION

1. Field of the Invention

The present invention generally relates to a method for resetting a micro controller and, more particularly, to a method for resetting a micro controller using an improved micro controller reset circuit designed for loading micro controller options (MCU options) in advance regardless of whether a reset key is pressed after the power is turned on. Therefore, the initial values of the micro controller are recovered so as to reduce power consumption and avoid conflict of signals.

2. Description of the Prior Art

Hand-held electronic products such as personal digital assistants (PDAs) and mobile phones may be mal-functional during operation since hardware may be crashed due to poor configuration setup or its incompatibility with software. These hand-held electronic products may stay mal-functional even after they are rebooted unless a reset key installed thereon is pressed so as to reset the operation software to initial conditions.

Please refer to FIG. 1, which is a flowchart of a conventional method for resetting a micro controller. In FIG. 1, after the power is turned on 11, the reset key has to be released so as to load the micro controller options (MCU options) 14. If the reset key is pressed 12 after the power is turned on 11, the micro controller cannot be initialized 15. When the micro controller is not initialized to provide options selected by the user, the user has to go through the setting process again, which lead to waste of time and power. And even worse, conflict occurs between signals from time to time. For example, the micro controller has a pin that provides an input/output function. If the pin is initialized as output while the pin is initialized by the user interface as input, the system will be crashed when the reset key is kept being pressed since the pin cannot be reset as input and conflict between input signal and output signal occurs.

Therefore, there exists a need in providing a method for resetting a micro controller to avoid the above-mentioned problem.

### SUMMARY OF THE INVENTION

It is a primary object of the present invention to provide a method for resetting a micro controller, using an improved micro controller reset circuit designed for loading MCU options regardless of whether a reset key is pressed after the power is turned on. In this method, the initial values of the micro controller are recovered because the MCU options are loaded in advance so as to reduce power consumption and avoid incompatibility.

In order to achieve the foregoing object, the present invention provides a method for resetting a micro controller, comprising steps of:
(a) turning on the power;
(b) loading micro controller options;
(c) determining whether a reset key is being pressed;
(d) performing reset;
(e) re-loading micro controller options; and
(f) initializing the micro controller.

Preferably, the step (d) is performed when the reset key is being pressed in step (c) or the step (f) is performed when the reset key is not being pressed in step (c).

Preferably, the step (d) is performed if the reset key is being pressed when the step (f) is performed.

Preferably, the step (d) is performed if the reset key is being pressed when the step (d) is performed or the step (e) is performed if the reset key is not being pressed when the step (d) is performed.

Preferably, the step (d) is performed if the reset key is being pressed when the step (e) is performed or the step (f) is performed if the reset key is not being pressed when the step (e) is performed.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a flowchart of a conventional method for resetting a micro controller; and

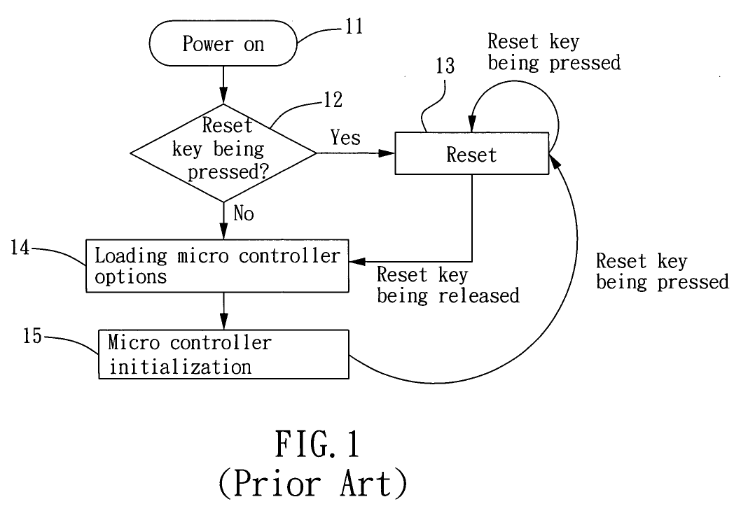

FIG. 2 is a flowchart of a method for resetting a micro controller according to the present invention.

### DETAILED DESCRIPTION OF THE PREFERRED EMBODIMENT

The present invention providing a method for resetting a micro controller can be exemplified by the preferred embodiment as described hereinafter.

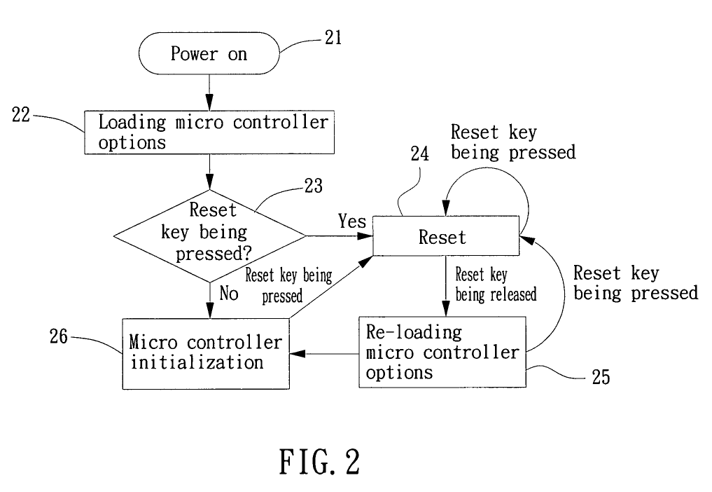

Please refer to FIG. 2, which is a flowchart of a method for resetting a micro controller according to the present invention. Right after the power is turned on 21, the MCU options are loaded 22 regardless of whether or not the reset key is pressed (that means, the reset key has no effect at all), as shown in FIG. 2. Only after the MCU options are loaded 22, the reset key can reset the micro controller according to whether the reset key is being pressed 23. Two initializing modes are described hereinafter:

First Mode: If the reset key is released after being pressed, the micro controller is to be initialized 26.

Second Mode: If the reset key is kept being pressed, the micro controller is kept being reset 24 until the reset key is released to re-load the MCU options 25. When the MCU options are re-loaded 25, the micro controller is to be reset 24 if the reset key is pressed, otherwise the micro controller is to be initialized 26 after the MCU options are re-loaded 25 (if the reset key is un-pressed). When the micro controller is initialized 26, the micro controller is to be reset 24 if the reset key is pressed.

According to the description with reference to FIG. 2, it is therefore understood that the present invention is aimed at providing a method for resetting a micro controller so as to reduce power consumption and avoid conflict between signals. The present invention uses an improved micro controller reset circuit designed for loading MCU options regardless of whether a reset key is pressed after the power is turned on. In this method, the micro controller is able to load MCU options in advance to recover initial values of the micro controller so as to reduce power consumption and avoid conflict between signals.

More particularly, the method of the present invention is characterized in that the reset key of the micro controller is ineffective, owing to being locked, after the power is turned on. The reset key won't become effective until the MCU options are first loaded so that system crash or conflict between signals can be avoided.

Furthermore, in the method of the present invention, other steps, such as power supply stable time for integrated circuit (IC) or stable time for other devices, can be executed prior to loading the MCU options after the power is turned on.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for resetting a micro controller, comprising steps of:
(a) turning on the power;
(b) loading micro controller options;
(c) determining whether a reset key is being pressed;
(d) performing reset;
(e) re-loading micro controller options; and
(f) initializing the micro controller.

2. The method for resetting a micro controller as recited in claim 1, wherein the step (d) is performed when the reset key is being pressed in step (c) or the step (f) is performed when the reset key is not being pressed in step (c).

3. The method for resetting a micro controller as recited in claim 1, wherein the step (d) is performed if the reset key is being pressed when the step (f) is performed.

4. The method for resetting a micro controller as recited in claim 1, wherein the step (d) is performed if the reset key is being pressed when the step (d) is performed or the step (e) is performed if the reset key is not being pressed when the step (d) is performed.

5. The method for resetting a micro controller as recited in claim 1, wherein the step (d) is performed if the reset key is being pressed when the step (e) is performed or the step (f) is performed if the reset key is not being pressed when the step (e) is performed.
